(19) United States
(12) Patent Application Publication
(10) Pub. No.: US 2014/0092033 A1
(43) Pub. Date: Apr. 3, 2014

(54) TOUCH DETECTION METHOD FOR TOUCH PANEL

(71) Applicant: NOVATEK MICROELECTRONICS CORP., Hsinchu (TW)

(72) Inventors: Hui-Hung Chang, Keelung City (TW); Chun-Hung Chen, Taipei City (TW)

(73) Assignee: Novatek Microelectronics Corp., Hsinchu (TW)

(21) Appl. No.: 13/747,486

(22) Filed: Jan. 23, 2013

(30) Foreign Application Priority Data
Sep. 28, 2012 (TW) 101136003

(51) Int. Cl. G06F 3/041

(52) U.S. Cl. CPC G06F 3/041
USPC 345/173

(57) ABSTRACT

A touch detection method for a touch panel. The touch panel has a plurality of sensing nodes. Each sensing node has a baseline value. Each sensing node is sensed to obtain a scanned value. A touch event is detected according to a comparison with a finger-on threshold. When there is no touch event, the method detects whether or not an abnormal object has entered the sensing node. When entered, the method judges whether a difference count between the scanned value and baseline value is larger than a calibration level. When the difference count is larger, then the scanned value is used to update the baseline value. When no abnormal object, then the method judges whether the difference count is larger than a noise threshold. When the difference count is larger, then the scanned value is used to update the baseline value. The calibration level is smaller than finger-on threshold.

### CROSS-REFERENCE TO RELATED APPLICATION

This application claims the priority benefit of Taiwan application serial no. 101136003, filed on Sep. 28, 2012. The entirety of the above-mentioned patent application is hereby incorporated by reference herein and made a part of this specification.

### BACKGROUND

1. Technical Field

The invention relates generally to a touch detection method of a touch panel capable of instantaneously detecting an abnormal touch event caused by the environment.

2. Related Art

The touch panel is widely applied in electronic products, where the touch panel is typically integrated with the display panel and allows touch operations to the display panel and the connected host. For example, in the tablet computer or the smartphone, the commands are all achieved by touch operations.

Many types of touch panels are available, and one of the touch panel designs adopts an array of sensing nodes. FIG. 1 is a schematic structural view of a conventional touch panel.

With reference to FIG. 1, a design of a touch panel 100 includes m×n driving lines and sensing lines. The driving lines are represented by y, and the sensing lines are represented by x. When using a mutual sensing method to detect a touch location, first a plurality of driving pulses are inputted at a y0-ym end respectively by a time-division method through the amplifiers 102. Every time a driving voltage is inputted, at the same time, a raw data is converted by an analog-to-digital converter (ADC) 104 to serve as a baseline of a sensing node at an X-Y intersection. After sensing a baseline frame, the baselines of all of the sensing nodes can be obtained. Thereafter, according to the baselines and the scanned values of the scan frame, whether a touch event of a finger or another object can be determined, as well as the touch location.

FIG. 2 is a schematic diagram of establishing the baselines of a conventional touch panel. With reference to FIG. 2, observing for a single sensing node, sensing at an earliest time usually does not have a touch object, and so the obtained scanned value is used to establish a baseline value, which is also referred to as a first scanned value. Moreover, a finger-on threshold is determined by subtracting a predetermined difference value from the baseline value. The finger-on threshold is not limited to the finger touch, but refers to a broad range of touch objects. If the scanned value of each subsequent sensing is below the finger-on threshold, then the finger touch can be determined. On the contrary, if the scanned value of each sensing is not below the finger-on threshold, then no touch has occurred. As shown an arrow in FIG. 2, a difference count is a result after subtracting the scanned value from the baseline value. Moreover, for a same sensing node during a sensing period, a scanned value is obtained by a periodic scan operation. Therefore, as to different sensing periods, the scanned value changes by a small amount relative to the baseline value. A curve illustrated in FIG. 2 is drawn by joining scanned values obtained after each sensing.

FIG. 3 is schematic diagram illustrating a conventional mechanism for detecting whether there is a finger touch or press event. With reference to FIG. 3, continuing to the sensing period from FIG. 2, during a region 120 the finger is in a state of being away from the touch panel. Accordingly, the scanned value varies near from the baseline value, but does not become lower than the finger-on threshold. During a region 122, the finger begins to touch the touch panel. At this time, the sensed value on a touched sensing node is lower than the finger-on threshold, and accordingly whether a touch or press event has occurred at this sensing node can be determined. It should be known, however, that the area of a touch event typically extends to a plurality of sensing nodes, but for the detection of a single sensing node, the afore-described method determines whether a touch has occurred.

When an abnormal object such as a water drop, a liquid droplet, or other adhesive objects touches the panel, a misjudged touch event may be generated. Accordingly, how to prevent environmental elements from causing the touch panel to misjudge touch events is one of the considerations for designing the detection mechanism of the touch panel.

### SUMMARY OF THE INVENTION

An embodiment of the invention provides a touch detection technique for a touch panel capable of instantaneously detecting an abnormal touch event caused by the environment.

An embodiment of the invention provides a touch detection method for a touch panel. The touch panel has a sensing line corresponding to each of a plurality of analog-to-digital converters (ADCs) of the touch panel, and each of the sensing lines has a plurality of sensing nodes. The touch detection method includes the following steps. A baseline value is established for each of the sensing nodes of a frame to be scanned. Each of the sensing nodes of the frame is scanned to obtain a plurality of scanned values. An analysis below is performed for each of the sensing nodes. Whether or not a touch event occurred is detected. When a touch event has occurred, the analysis proceeds to the next sensing node. Whether or not the touch event has occurred is determined according to whether or not the scanned value is larger than or equal to a finger-on threshold. When no touch event has occurred, whether or not an abnormal object has entered the sensing node is determined. When the abnormal object has entered the sensing node, whether or not a difference count between the scanned value and the baseline value is larger than a calibration level is determined. When the difference count is larger than the calibration level, the baseline value corresponding to the sensing node is updated with the scanned value, and the next sensing node is analyzed. When the difference count is not larger than the calibration level, the next sensing node is analyzed. When no abnormal object has entered the sensing node, whether or not the difference count is larger than a noise threshold is determined. When the difference count is larger than the noise threshold, the baseline value corresponding to the sensing node is updated with the scanned value, and the next sensing node is analyzed. When the difference count is not larger than the noise threshold, the next sensing node is analyzed. When the analysis of each of the sensing nodes is completed, the sensing of the frame is complete. Moreover, the calibration level is smaller than the finger-on threshold.

An embodiment of the invention provides a touch detection method for a touch panel. The touch panel has a plurality of sensing lines, each of the sensing lines has a plurality of sensing nodes, and each of the sensing nodes has a baseline value. The touch detection method includes the following steps. Each of the sensing nodes is sensed to obtain a scanned value. Whether or not a touch event occurred is detected, in which the touch event is determined to have occurred when the scanned value is larger than or equal to a finger-on threshold. When no touch event has occurred, whether or not an abnormal object has entered the sensing node is determined. When the abnormal object has entered the sensing node, whether or not a difference count between the scanned value and the baseline value is larger than a calibration level is determined. When the difference count is larger than the calibration level, the baseline value corresponding to the sensing node is updated with the scanned value. When the difference count is not larger than the calibration level, the next sensing node is sensed.

When no abnormal object has entered the sensing node, whether or not the difference count is larger than a noise threshold is determined. When the difference count is larger than the noise threshold, the baseline value corresponding to the sensing node is updated with the scanned value. When the difference count is not larger than the noise threshold, the next sensing node is sensed. Moreover, the calibration level is smaller than the finger-on threshold.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a conventional touch panel.

FIG. 2 is a schematic diagram of establishing the baseline values of a conventional touch panel.

FIG. 3 is schematic diagram illustrating a conventional mechanism for detecting whether there is a finger touch or press event.

FIG. 4 is a schematic diagram illustrating a baseline value variation when a touch panel has residue water according to an embodiment of the invention.

FIG. 5 is a schematic diagram illustrating a baseline value variation when a touch panel has residue water according to an embodiment of the invention.

FIG. 6A is a schematic structural view of a touch panel according to an embodiment of the invention.

FIG. 6B is a schematic diagram of a scanned value variation when establishing the baseline value according to an embodiment of the invention.

FIG. 7A is a schematic view of a touch panel having an abnormal object entering according to an embodiment of the invention.

FIG. 7B is a schematic diagram of a scanned value variation when an abnormal object enters during the establishment of the baseline value according to an embodiment of the invention.

FIG. 8 is a schematic diagram illustrating a variation between a normal scanned value and a baseline value according to an embodiment of the invention.

FIG. 9 is a schematic diagram of a mechanism considering an abnormal object is removed according to an embodiment of the invention.

FIG. 10 is a schematic diagram of a mechanism when an abnormal object is misjudged as being removed according to an embodiment of the invention.

FIG. 11 is a flow diagram of a touch detection method according to an embodiment of the invention.

### DETAILED DESCRIPTION OF THE EMBODIMENTS

The touch detection techniques of the touch panel according to embodiments of the invention are capable of instantaneously detecting an abnormal touch event caused by the environment, such as detecting a state when an abnormal object touches the touch panel, for example, or detecting the instantaneous state when the abnormal object is removed. The abnormal objects are commonly known as liquid droplets or other miscellaneous objects.

Several embodiments are described below to further illustrate the invention. However, the invention is not limited to the embodiments described in the specification.

For example, before establishing the baseline value of the sensing node, residue water may have been left on the touch panel. At this time, if the baseline value is established, the sensed baseline value would include the effect from the water. Therefore, the capacitance baseline value of the sensing node touched by the residue water deviates from the original baseline value to generate a state similar to a touch event. Moreover, during operation, a sudden water entry would also cause the water effect to be included. Therefore, for the baseline value observed during operation, a baseline value including the water is typically higher than a baseline value without water. If the water is suddenly removed, then the increased baseline value generated by the water should also be discarded. However, when the effect of the water has not been removed at the system end, each scan frame would generate a misjudged action. Further details are further elucidated as follows.

FIG. 4 is a schematic diagram illustrating a baseline value variation when a touch panel has residue water according to an embodiment of the invention. With reference to FIG. 4, a region 130 depicts a situation when there is residue water on the touch panel during an establishment of a baseline value. The baseline value at this time is obtained after a first scan. If the residue water has not been removed, then the scanned value varies near the baseline value having the effect from the water. A finger-on threshold is set according to the baseline value, and therefore the finger-on threshold also shifts higher as well. The scanned value is not lower than the finger-on threshold. However, in a region 132, when the abnormal object is removed, even if there is a touch, the scanned value thereof drops because of the removal of the abnormal object. When the scanned value drops below the finger-on threshold, since the baseline value and the finger-on threshold are maintained in the state of region 130, the scanned value in region 132 would be lower than the finger-on threshold, and thereby resulting in a misjudged touch event.

FIG. 5 is a schematic diagram illustrating a baseline value variation when a touch panel has residue water according to an embodiment of the invention. With reference to FIG. 5, if the residue water in a region 134 is removed and the finger-on threshold is sufficiently large, the scanned value is not lower than the finger-on threshold but is close to it. In other words, relative to the region 134, if the finger-on threshold is too small, the scanned value is easily lower than the finger-on threshold. Accordingly, this results in an over sensitive phenomenon and belongs to one of the abnormal operation issues.

Moreover, if the finger-on threshold is set larger to prevent the misjudged action from the water removal, the sensitivity is inadequate for a real finger touch due to the large finger-on threshold. Since setting the value of the finger-on threshold is related to the water area, how to set the finger-on threshold is also an issue. Similar problems also exist for objects other than water.

A touch detection method according to an embodiment of the invention is capable of determining whether water or other objects have entered the touch panel before establishing the baseline value, so as to automatically correct the baseline value. The corrected baseline value is not affected by the objects initially on the touch panel, and therefore a finger touch can be correctly detected. If the objects on the touch panel have been removed initially, the baseline value is automatically updated, and the finger touch can still be correctly judged. If an abnormal object enters during operation, the baseline value is updated. When the abnormal object is removed, the baseline value is automatically updated, and the finger touch can still be correctly judged.

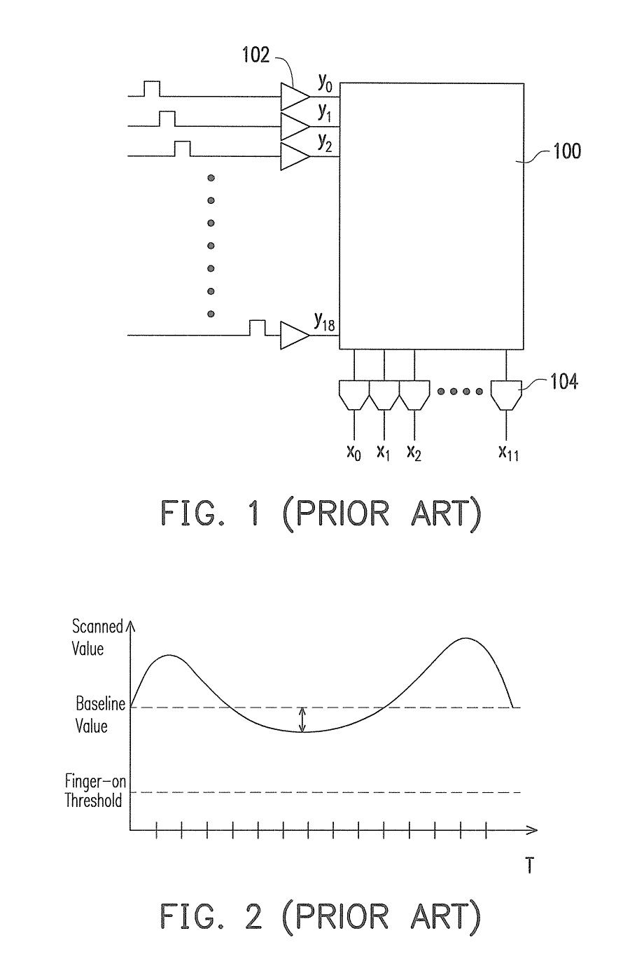

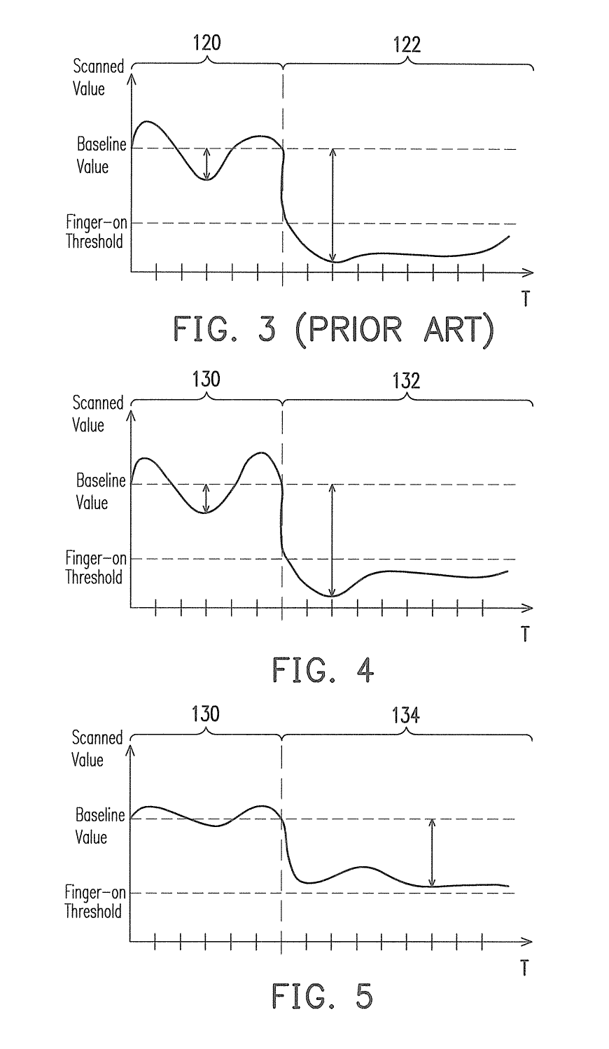

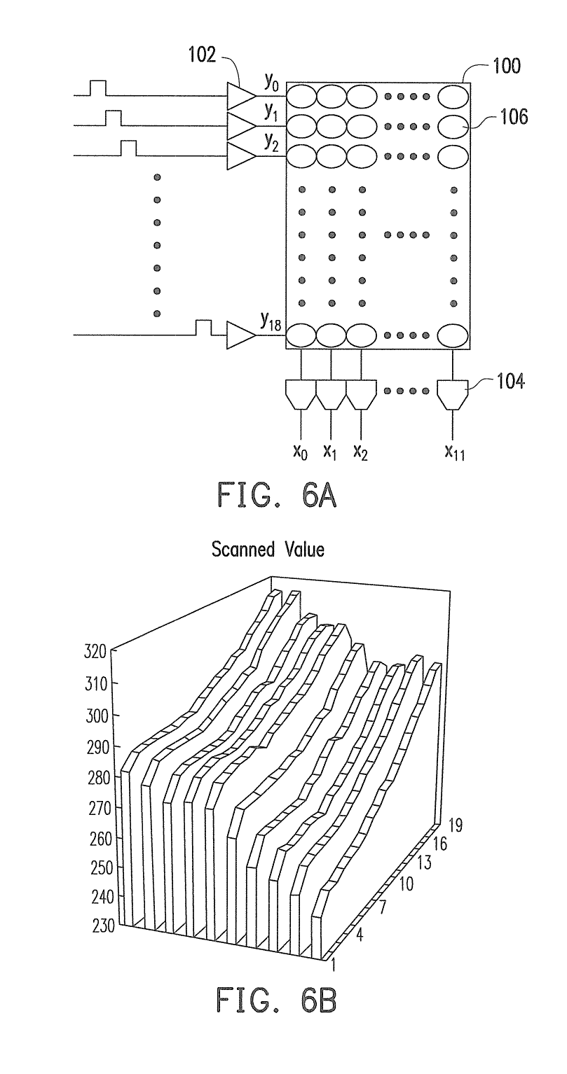

FIG. 6A is a schematic structural view of a touch panel according to an embodiment of the invention. With reference to FIG. 6A, the structure of a touch panel 100 is similar to FIG. 1, although the exemplary embodiment provides different considerations and processing to a sensing node 106 on the touch panel 100. At this time, the state of the touch panel 100 is such that there's no actual touch and no abnormal objects have entered the touch panel 100. In a typical normal state, the touch panel 100 is first scanned to establish a baseline value of the sensing node 106.

In the present embodiment, the driving lines are labeled y0 to y18, and the sensing lines are labeled x0 to x11, for example. Each of the sensing nodes has a capacitance baseline value that is a converted value by an analog-to-digital converter (ADC) 104.

FIG. 6B is a schematic diagram of a scanned value variation when establishing the baseline value according to an embodiment of the invention. With reference to FIGS. 6A and 6B, if a same ADC 104 is used to sense a same direction, the scanned values of the sensing nodes sensed by the same ADC 104 would be near to one another and have a gradient variation. A reason for the gradient variation is due to the gradually increasing resistance of the sensing lines, but the scanned values with gradually increasing, are within a limited range.

Looking at the distribution of the numerical values, such as a distribution shown in Table 1, for example, although the numerical values are different, the variation is not large. Moreover, a same sensing line has a smooth variation.

TABLE 1

| | x | | | | | | | | | |
|---|---|---|---|---|---|---|---|---|---|---|
| y | 0 | 1 | 3 | 4 | 5 | 6 | 7 | 8 | 9 | 10 |
| 0 | 244 | 250 | 254 | 257 | 265 | 274 | 275 | 274 | 279 | 282 |
| 1 | 250 | 257 | 261 | 265 | 273 | 280 | 281 | 281 | 284 | 286 |
| 2 | 250 | 258 | 260 | 265 | 273 | 281 | 282 | 282 | 285 | 287 |
| 3 | 252 | 259 | 261 | 265 | 273 | 282 | 283 | 282 | 285 | 287 |
| 4 | 253 | 259 | 262 | 265 | 274 | 282 | 282 | 282 | 285 | 287 |
| 5 | 254 | 260 | 262 | 265 | 274 | 283 | 282 | 282 | 285 | 287 |
| 6 | 256 | 261 | 261 | 265 | 274 | 281 | 283 | 282 | 285 | 288 |
| 7 | 259 | 263 | 265 | 268 | 276 | 284 | 284 | 283 | 287 | 288 |
| 8 | 261 | 265 | 266 | 269 | 276 | 285 | 286 | 286 | 289 | 291 |
| 9 | 264 | 269 | 268 | 273 | 278 | 287 | 289 | 288 | 291 | 293 |
| 10 | 265 | 271 | 270 | 277 | 280 | 289 | 289 | 291 | 292 | 295 |
| 11 | 269 | 274 | 273 | 276 | 283 | 290 | 292 | 292 | 295 | 296 |
| 12 | 272 | 276 | 275 | 278 | 284 | 292 | 293 | 291 | 296 | 299 |
| 13 | 276 | 280 | 279 | 281 | 289 | 295 | 295 | 295 | 300 | 300 |
| 14 | 280 | 284 | 283 | 285 | 292 | 299 | 299 | 299 | 304 | 304 |
| 15 | 283 | 288 | 287 | 287 | 295 | 301 | 303 | 302 | 307 | 307 |
| 16 | 288 | 292 | 290 | 291 | 298 | 303 | 304 | 306 | 309 | 310 |
| 17 | 292 | 295 | 292 | 293 | 299 | 306 | 305 | 307 | 312 | 314 |
| 18 | 293 | 295 | 291 | 290 | 285 | 299 | 303 | 307 | 315 | 315 |

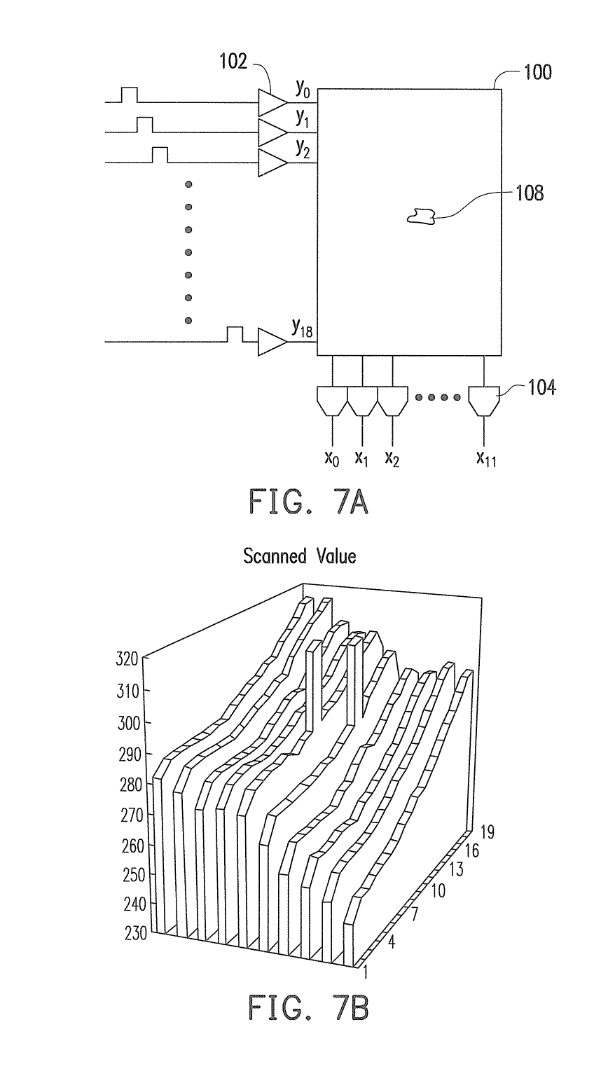

FIG. 7A is a schematic view of a touch panel having an abnormal object entering according to an embodiment of the invention. FIG. 7B is a schematic diagram of a scanned value variation when an abnormal object enters during the establishment of the baseline value according to an embodiment of the invention.

With reference to FIG. 7A, the touch panel 100 has an abnormal object 108 thereon, such as a water droplet, for example. If the baseline value is established at this time, as shown in FIG. 7B, then an abnormal and abrupt increase of the baseline value would result.

Looking at the distribution of the numerical values, such as a distribution shown in Table 2, for example, the numerical values of the scanned values abruptly increase at the sensing nodes of the abnormal object 108, and the increased level is clearly larger than the other sensing nodes.

TABLE 2

| | x | | | | | | | | | |
|---|---|---|---|---|---|---|---|---|---|---|
| y | 0 | 1 | 3 | 4 | 5 | 6 | 7 | 8 | 9 | 10 |
| 0 | 244 | 250 | 254 | 257 | 265 | 274 | 275 | 274 | 279 | 282 |
| 1 | 250 | 257 | 261 | 265 | 273 | 280 | 281 | 281 | 284 | 286 |
| 2 | 250 | 258 | 260 | 265 | 273 | 281 | 282 | 282 | 285 | 287 |
| 3 | 252 | 259 | 261 | 265 | 273 | 282 | 283 | 282 | 285 | 287 |
| 4 | 253 | 259 | 262 | 265 | 274 | 282 | 282 | 282 | 285 | 287 |
| 5 | 254 | 260 | 262 | 265 | 274 | 283 | 282 | 282 | 285 | 287 |
| 6 | 256 | 261 | 261 | 265 | 274 | 281 | 283 | 282 | 285 | 288 |
| 7 | 259 | 263 | 265 | 268 | 276 | 284 | 284 | 283 | 287 | 288 |
| 8 | 261 | 265 | 266 | 269 | 276 | 285 | 286 | 286 | 289 | 291 |
| 9 | 264 | 269 | 268 | 273 | 309 | 313 | 289 | 288 | 291 | 293 |
| 10 | 265 | 271 | 270 | 277 | 311 | 318 | 289 | 291 | 292 | 295 |
| 11 | 269 | 274 | 273 | 276 | 283 | 290 | 292 | 292 | 295 | 296 |
| 12 | 272 | 276 | 275 | 278 | 284 | 292 | 293 | 291 | 296 | 299 |
| 13 | 276 | 280 | 279 | 281 | 289 | 295 | 295 | 295 | 300 | 300 |
| 14 | 280 | 284 | 283 | 285 | 292 | 299 | 299 | 299 | 304 | 304 |
| 15 | 283 | 288 | 287 | 287 | 295 | 301 | 303 | 302 | 307 | 307 |
| 16 | 288 | 292 | 290 | 291 | 298 | 303 | 304 | 306 | 309 | 310 |
| 17 | 292 | 295 | 292 | 293 | 299 | 306 | 305 | 307 | 312 | 314 |
| 18 | 293 | 295 | 291 | 290 | 285 | 299 | 303 | 307 | 315 | 315 |

The scanned values generated by the abnormal object 108 are shown as the bolded numerical values at the corresponding positions. For example, the scanned values 309, 311, 313, and 318 have been clearly increased compared to the neighboring scanned values.

Due to the baseline value variation caused by the abnormal object 108, and in order to accurately detect the actual touch event, several scenarios are considered below to provide a detection mechanism with better efficiency and accuracy.

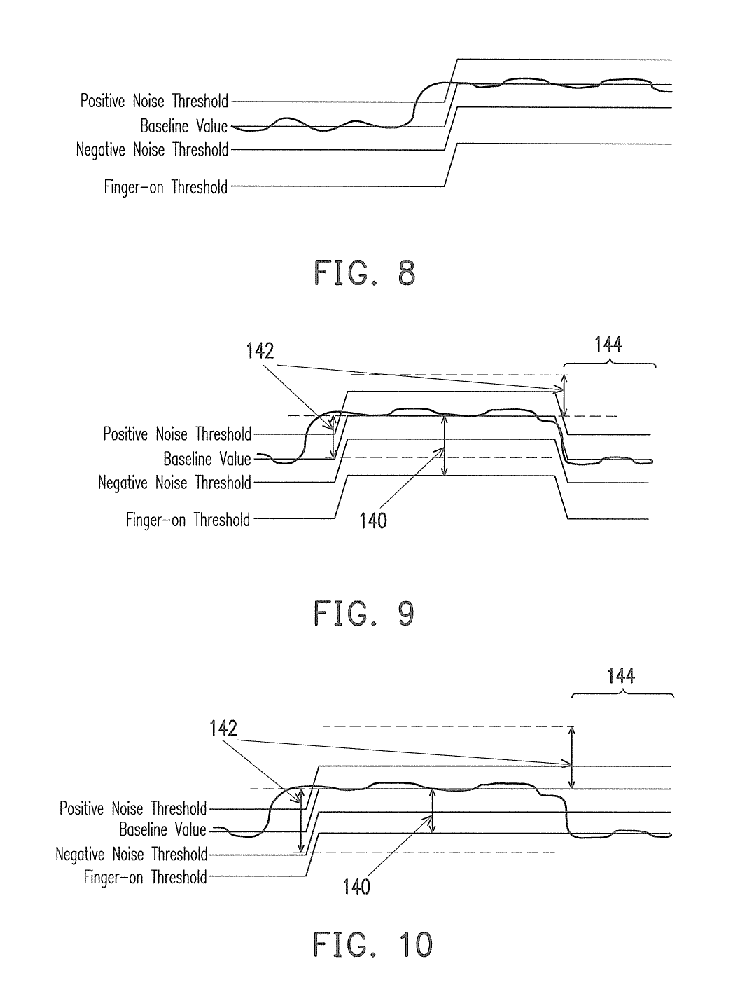

FIG. 8 is a schematic relational diagram illustrating the variations of a normal scanned value and a baseline value according to an embodiment of the invention. With reference to FIG. 8, each of the sensing nodes has a baseline value. Even if an abnormal object exists on the sensing node, the baseline value thereof is correspondingly updated. If there is no actual touch at the sensing node, for each scan relative to time, the scanned value varies near the baseline value. In other words, for a normal scanned value, a difference count between the scanned value and the baseline value should be smaller than a range between a positive noise threshold and a negative noise threshold. If the difference count is larger than a noise boundary of the positive noise threshold or the negative noise threshold, then conditions have changed. For example, the operating environment has changed or an abnormal object has entered, and the baseline value includes the effect of the changed conditions and is updated accordingly.

FIG. 9 is a schematic diagram of a mechanism considering an abnormal object is removed according to an embodiment of the invention. With reference to FIG. 9, a sensed value is obtained from a sensing node from a sensing circuit. Moreover, the sensed value is not determined to be noise, and no abnormal object is on the sensing node. A finger-on threshold 140 is set according to the baseline value. During operation, an abnormal object may enter the sensing node, and the baseline value may be accordingly updated. In order to determine whether or not the abnormal object has entered the sensing node, the present embodiment sets a calibration level 142 relative to the baseline value. On a critical time point when the abnormal object enters, if a difference count is larger than or equal to the calibration level 142, then this implies the abnormal object has entered the sensing node. Therefore, the baseline value is updated, for example as shown in a middle region of FIG. 9. When the abnormal object, such as a water droplet, is removed and no touch event has occurred, the difference count is lowered on the critical time point due to the removal of the abnormal object, and accordingly the difference count exceeds a current calibration level 142. Therefore, since the scanned value is still smaller than the finger-on threshold 140, no touch event wound still be detected out. However, since the water droplet has been removed, the baseline value should be updated, or else the misjudging issues as previously illustrated in FIGS. 4 and 5 would be generated. After the baseline value in a region 144 is updated, the baseline value is lowered to a normal level. After an equivalent capacitance baseline value of the touch panel is updated, normal operation can be continually maintained.

It should be noted that, if the calibration level 142 is set too large and exceeds the finger-on threshold 140, then a wrong detection may also be generated. FIG. 10 is a schematic diagram of a mechanism when an abnormal object is misjudged as being removed according to an embodiment of the invention. With reference to FIG. 10, if the calibration level 142 is larger than the finger-on threshold 140, then in the region 144, after the state with the water droplet is removed, the difference count may first exceed the finger-on threshold 140 but is still smaller than the calibration level 142. The baseline value is not updated to the equivalent capacitance baseline value at this time, and since the scanned value is smaller than the finger-on threshold 140, erroneous detection of a finger touch would occur.

In other words, the calibration level 142 needs to be smaller than the finger-on threshold 140, although the actual setting value may be set according to the practical conditions.

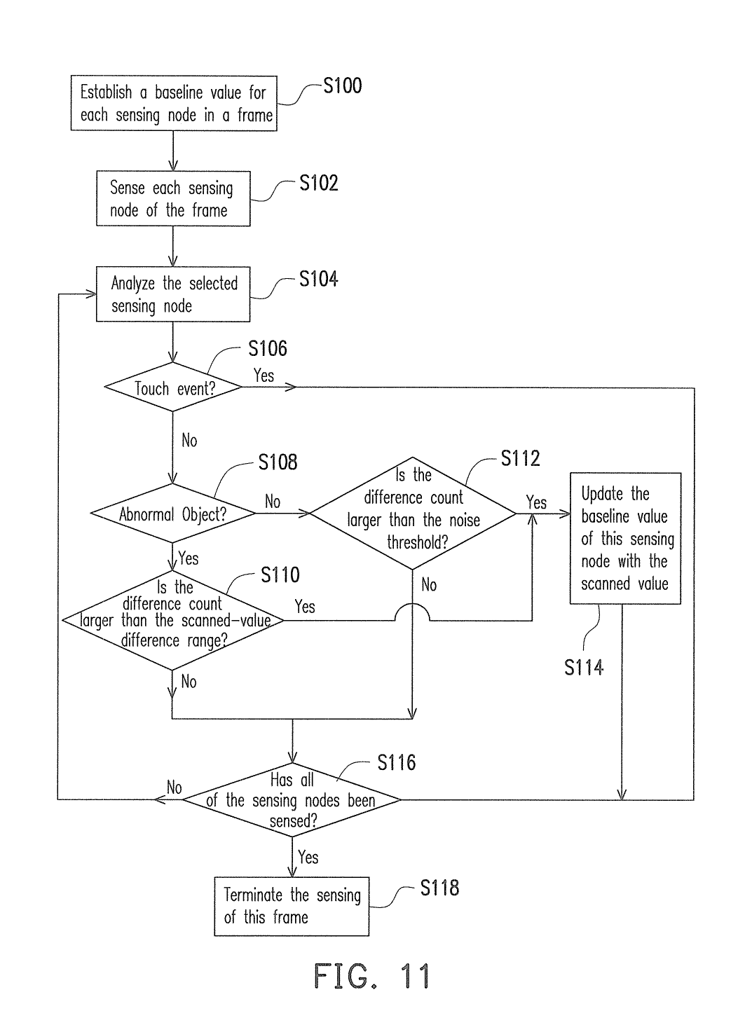

A touch detection method is described hereafter. FIG. 11 is a flow diagram of a touch detection method according to an embodiment of the invention. With reference to FIG. 11, in Step S100, a baseline value is established for each of the sensing nodes in a frame. In order to establish the baseline value for each of the sensing nodes in a frame, a new measurement may be performed. Alternatively, the previous baseline value of the frame may be maintained, especially when the baseline value contains updated data. However, when initially there is no baseline value data, a new measurement must be performed. In other words, for a frame to sense, each of the sensing nodes needs a baseline value. The baseline value may be acquired from a specific measurement or obtained from the baseline value of a previous state. In Step S102, each of the sensing nodes of the frame is sensed. In Step S104, a subsequent analysis for the selected sensing node is performed. In Step S106, whether a touch event occurred is detected. Moreover, a detection condition of whether the touch event has occurred is according to whether a difference count of the scanned value is larger than the finger-on threshold 140, for example. When a touch event has occurred, the process proceeds to Step S116 after recording a touch state of this sensing node. Step S116 checks whether all of the sensing nodes have been detected. When there are still sensing nodes that haven't been detected, the process returns to Step S104 to detect the next sensing node. When all of the sensing nodes have been detected, the process proceeds to Step S118, and the sensing of this frame is terminated.

When Step S106 has a detection result with no touch event occurred, the process enters Step S108 which determines whether or not an abnormal object has entered this sensing node. When no abnormal object has entered this sensing node, the process enters Step S112 which determines whether or not the difference count is larger than a noise threshold. When the difference count is larger than the noise threshold, the process enters Step S114 which updates the baseline of this sensing node with the scanned value. This situation is generated when the previous abnormal object is removed, and therefore the baseline value can be updated instantly. In another situation, when the difference count is larger than the noise threshold, then the process enters the aforementioned Step S116.

Moreover, when the result of Step S106 is that the abnormal object has entered this sensing node, then the process enters Step S110. In Step S110, whether the difference count is larger than a calibration level is determined. When the difference count is larger than the calibration level, the process enters Step S114 which updates the baseline value of this sensing node with the scanned value. When the difference count is not larger than the calibration level, the process enters Step S116.

Here, the calibration level should be smaller than the finger-on threshold, so as to ensure the update of the baseline value, and to reduce the misjudged phenomenon shown in FIG. 10, for example.

With regards to Step S108, whether the abnormal object has entered can be detected by a plurality of methods. For example, the scanned values of the sensing nodes on a sensing line can be analyzed according to (a) a median value; (b) an overall average value; (c) an average of several substantially small scanned values; or by comparing a before and after variation of scanned values.

The median value method is used as an illustrative example for description, as shown in Table 3.

TABLE 3

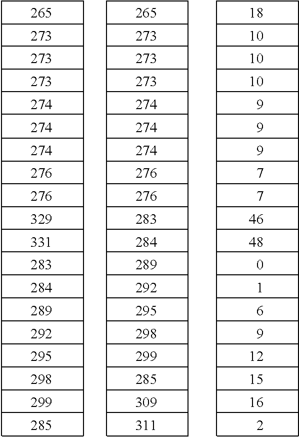

With reference to Table 3, the scanned values for the sensing nodes on a sensing line corresponding to a same ADC are respectively shown in the left column of Table 3. When an abnormal object enters, the scanned values deviate higher, as shown by 329 and 331 labeled by the shadows, for example.

As shown in the middle column of Table 3, the scanned values are ordered according to size. A scanned value of the sensing nodes near the middle is taken from the ordered scanned values of the middle column. For example, the 10^{th} sensing node with scanned value 283 in the 19 sensing nodes is used as a reference value. However, the sensing node near the middle does not have to be the absolute median point. The difference counts in the right column are obtained by calculating the absolute differences between the left column values and reference value. If the sensing node has an abnormal object, the difference counts of the sensing nodes on the boundary of the abnormal object are drastically increased, as shown by 46 and 48. According to a suitable threshold setting, such as 30, whether the abnormal object has entered can be determined by comparing the boundary difference counts with the threshold value. This embodiment uses the median value as the reference value for an illustrative example.

In another embodiment, the reference value may be an average value of the scanned values on all of the sensing lines, and the abnormal objection detection may be performed according to the afore-described method, although the threshold may be changed correspondingly.

In another embodiment, the reference value may be an average value of a reasonable number of smaller scanned values on sensing lines, such as an average value of five or fewer substantially smallest values, or an average value of the two or three substantially smallest values, and the abnormal objection detection may be performed according to the afore-described method, although the threshold may be changed correspondingly.

In another embodiment, when the reference value method is not adopted, whether the abnormal object has entered may be determined by comparing a before and after variation of scanned sensing node values from a same ADC.

The state of whether the sensing nodes have abnormal objects can be recorded for subsequent analysis and comparison.

The touch detection method according to embodiments of the invention can instantaneously update the baseline values of the sensing nodes according to the state of the abnormal objects, and thereby reduce the probability of misjudging the touch event.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A touch detection method for a touch panel, wherein the touch panel has a sensing line corresponding to each of a plurality of analog-to-digital converters (ADCs) of the touch panel, and each of the sensing lines has a plurality of sensing nodes, the touch detection method comprising:
establishing a baseline value for each of the sensing nodes of a frame to sense;
sensing each of the sensing nodes of the frame to obtain a plurality of scanned values;
performing an analysis for each of the sensing nodes, the analysis comprising:
detecting whether or not a touch event occurred, when a touch event has occurred, the analysis proceeding to the next sensing node, wherein whether or not the touch event has occurred is determined according to whether or not the scanned value is larger than or equal to a finger-on threshold;
determining whether or not an abnormal object has entered the sensing node when no touch event has occurred;
determining whether or not a difference count between the scanned value and the baseline value is larger than a calibration level when the abnormal object has entered the sensing node;
updating the baseline value corresponding to the sensing node with the scanned value, and continuing with the analysis to the next sensing node when the difference count is larger than the calibration level;
continuing with the analysis of the next sensing node when the difference count is not larger than the calibration level;
determining whether or not the difference count is larger than a noise threshold when no abnormal object has entered the sensing node;
updating the baseline value corresponding to the sensing node with the scanned value, and continuing with the analysis to the next sensing node when the difference count is larger than the noise threshold;
continuing with the analysis of the next sensing node when the difference count is not larger than the noise threshold; and
terminating the sensing of the frame when the analysis of each of the sensing nodes is completed,
wherein the calibration level is smaller than the finger-on threshold.

2. The touch detection method of claim 1, wherein determining whether or not the abnormal object has entered the sensing node comprises analyzing the scanned values of the sensing nodes on the sensing line, and determining the abnormal object has entered when finding the sensing node has a substantially larger scanned value than a threshold.

3. The touch detection method of claim 1, wherein the step of determining whether or not the abnormal object has entered the sensing node comprises:
ordering the scanned values of the same sensing line by size;
using one of the scanned values of the sensing node near a middle of the scanned values being ordered as a reference value;
calculating differences between the scanned values and the reference value; and
determining whether or not anyone of the differences is larger than a threshold to judge whether or not the abnormal object has entered.

4. The touch detection method of claim 1, wherein determining whether or not the abnormal object has entered the sensing node comprises:
using an average value of a number of substantially smaller scanned values of the sensing nodes on the same sensing line as a reference value;
calculating differences of the scanned values from the reference value; and
determining whether or not any of the differences is larger than a threshold to judge whether or not the abnormal object has entered.

5. The touch detection method of claim 1, wherein determining whether or not the abnormal object has entered the sensing node comprises:
using an average value of the scanned values of the sensing nodes on the same sensing line as a reference value;
calculating differences of the scanned values from the reference value; and
determining whether or not any of the differences is larger than a threshold to judge whether or not the abnormal object has entered.

6. The touch detection method of claim 1, wherein the step of determining whether or not the abnormal object has entered the sensing node comprises:
comparing a before and after variation of the scanned values of the sensing nodes on the same sensing line, and judging that the abnormal object has entered the sensing node when the variation is larger than the calibration level.

7. The touch detection method of claim 1, wherein the abnormal object comprises a water droplet, a liquid droplet, or an adhesive object.

8. A touch detection method for a touch panel, wherein the touch panel has a plurality of sensing lines, each of the sensing lines has a plurality of sensing nodes, each of the sensing nodes has a baseline value, the touch detection method comprising:
sensing each of the sensing nodes to obtain a scanned value;
detecting whether or not a touch event occurred, wherein the touch event occurs when the scanned value is larger than or equal to a finger-on threshold;
determining whether or not an abnormal object has entered the sensing node when no touch event has occurred;
determining whether or not a difference count between the scanned value and the baseline value is larger than a calibration level when the abnormal object has entered the sensing node;
updating the baseline value corresponding to the sensing node with the scanned value when the difference count is larger than the calibration level;
continuing sensing the next sensing node when the difference count is not larger than the calibration level;
determining whether or not the difference count is larger than a noise threshold when no abnormal object has entered the sensing node;
updating the baseline value corresponding to the sensing node with the scanned value when the difference count is larger than the noise threshold; and
when the difference count is not larger than the noise threshold, continuing sensing the next sensing node;
wherein the calibration level is smaller than the finger-on threshold.

9. The touch detection method of claim 8, wherein the step of determining whether or not the abnormal object has entered the sensing node comprises analyzing the scanned values of the sensing nodes on the sensing line, and determining the abnormal object has entered when finding the sensing node has a substantially larger scanned value than a threshold.

10. The touch detection method of claim 8, wherein the step of determining whether or not the abnormal object has entered the sensing node comprises:
arranging the scanned values on the same sensing line by size;
after the arrangement, using the scanned value of the sensing node near a middle part as a reference value;
calculating differences of the scanned values from the reference value; and
determining whether or not any of the differences is larger than a threshold to judge whether or not the abnormal object has entered.

11. The touch detection method of claim 8, wherein the step of determining whether or not the abnormal object has entered the sensing node comprises:
using an average value of a number of substantially smaller scanned values of the sensing nodes on the same sensing line as a reference value;
calculating differences of the scanned values from the reference value; and
determining whether or not any of the differences larger than a threshold to judge whether or not the abnormal object has entered.

12. The touch detection method of claim 8, wherein the step of determining whether or not the abnormal object has entered the sensing node comprises:
using an average value of the scanned values of the sensing nodes on the same sensing line as a reference value;
calculating differences of the scanned values from the reference value; and
determining whether or not the difference counts are larger than a threshold to judge whether or not the abnormal object has entered.

13. The touch detection method of claim 8, wherein determining whether or not the abnormal object has entered the sensing node comprises:
for the scanned values of the sensing nodes on the same sensing line, comparing a before and after variation of the scanned values, and judging the abnormal object has entered the sensing node when the variation is larger than the calibration level.

14. The touch detection method of claim 8, wherein the abnormal object comprises a water droplet, a liquid droplet, or an adhesive object.
